(19) United States
(12) Patent Application Publication
(10) Pub. No.: US 2010/0208180 A1
(43) Pub. Date: Aug. 19, 2010

(54) Negative Birefringement Polyester Films For LCD

(76) Inventors: Frank W. Harris, Boca Raton, FL (US); Limin Sun, Copley, OH (US); Dong Zhang, Uniontown, OH (US); Zhikuan Lu, Hudson, OH (US); John D. Harvey, Seville, OH (US); Koji Kigawa, Rye, NY (US)

Correspondence Address: George W. Moxon II;Moxon & Spriegel, Suite L 9 & 11-13, 110 West Streetsboro Road, Hudson, OH, 44236, US

(21) Appl. No.: 12/686,269

(22) Filed: Jan. 12, 2010

Related U.S. Application Data
(60) Provisional application No. 61/143,981, filed on Jan. 12, 2009.

(51) Int. Cl. G02F 1/13363; G02B 5/30

(52) U.S. Cl. 349/117; 359/494

(57) ABSTRACT

A non-stretched, negative birefringent copolyester film, which has been solution cast from toluene and/or MIBK and mixtures of these with other solvents on a substrate, and has a Δn_{⊥} of >0.02 and a DP between 0.90 and 1.10.

### PRIORITY CLAIM

The present application claims the benefit of Provisional Patent Application 61/143,981, filed Jan. 12, 2009, which application is incorporated herein by reference in its entirety.

### BACKGROUND OF THE INVENTION

The invention relates to the manufacture of negative birefringent polymer films for use in compensation layers in liquid crystal displays (LCDs). More particularly, the invention relates to the manufacture and use of aromatic polyesters, which have a rigid rod backbone for use in compensation layers in LCDs. The polyesters are soluble in toluene and/or methylisobutylketone (MIBK) and can be coated on a variety of polymer substrates to produce multi-layer polymeric optical films.

Liquid crystal displays (LCDs) are widely used today. However, there is an intrinsic viewing angle dependence with LCDs, which affects the quality of the display performance, such as contrast, coloration, and/or brightness. The primary factor limiting the quality of a LCDs' performance is the propensity of the light to leak through the liquid crystal elements or cell and, thus, reduce contrast. This leakage, which can be attributed to the birefringence in the cell, is dependent on the direction from which the display is viewed. The best quality LCD picture is observed only within a narrow viewing angle range centered perpendicular to the display screen.

To increase the viewing angle, compensation films (C plates) can be applied to the LCD display. Several LCD modes, including Twisted Nematic (TN), Super Twisted Nematic (STN), Vertical Alignment (VA), and Optically Compensated Bend (OCB), with or without an applied field, have an inherent positive birefringence, which can be compensated for by a compensation film that displays a negative birefringence (a negative C plate).

The following terms have the definitions as stated below.
1. Optical axis herein refers to the direction in which propagating light does not see birefringence.
2. In-plane refractive indices is defined by n_{I}=(nₓ+n_{y})/2, where nₓ and n_{y} are refractive indices in the direction of x and y, and the x-y plane is parallel to the film plane.
3. In-plane birefringence is defined by Δn_{I}=(nₓ−n_{y}).
4. In-plane phase retardation is defined by R_{I}=(nₓ−n_{y})d, where d is a thickness of the film perpendicular to x-y plane, in the z direction.
5. Out of-plane birefringence is defined by Δn_{⊥}=n_{z}−(nₓ+n_{y})/2, where n_{z} is the refractive index in the z direction.
6. Out of-plane retardation is defined by R_{⊥}=[n_{z}−(nₓ+n_{y})/2]d.
7. Negative C-plate herein refers to the plate in which the optical axis is perpendicular to the plate and n_{z}<nₓ=n_{y}
8. The dispersion parameter (DP) is defined as Δn_{⊥} (450 nm)/Δn_{⊥} (550 nm), where Δn_{⊥} (450 nm) is the out of-plane birefringence measured at 450 nm, and Δn_{⊥} (550 nm) is the out of-plane birefringence measured at 550 nm. When DP is >1.10, the dispersion curve is referred to as normal; when DP is between 1.10 and 0.90, the dispersion curve is referred to as flat; when DP is <0.90, the dispersion curve is referred to as reversed.

In a compensation film with negative C-plate symmetry, the out-of-plane refractive index, n_{⊥} or n_{z}, is less than the in-plane refractive index, n_{I}=(nₓ+n_{y})/2, resulting in a negative out-of-plane birefringence, Δn_{⊥}=n_{z}−(nₓ+n_{y})/2<0 and, hence, a negative out-of-plane retardation, R_{⊥}=[n_{z}−(nₓ−n_{y})/2]d<0. These films have been prepared by several different methods, but the following two methods are preferred due to the feasibility and economic advantage: precision stretching of polymer films uniaxially or biaxially; and solution casting or coating of thin polymer films. Uniformity in stretched negative birefringent films is particularly hard to obtain in large area films. Furthermore, there is usually residual stress remaining in the stretched film, which can relax upon use and cause distortion problems (Mura) in the corners of the LCD. For large size displays, negative birefringent films prepared by the solution casting or coating method are preferred due to the ease of processing and the lack of residual stress.

The major way to utilize the casting or coating method is to apply a polymer solution directly on the surface of a component used in an LCD, such as a polarizer or a polarizer substrate. This procedure results in a thin film or coating being formed on the component upon the evaporation of the solvent. However, this procedure requires that the polymer be soluble in select solvents. The solvent must dissolve the polymer, which forms the negative birefringent film, but not dissolve or significantly swell the LCD component. The solvent must also be able to be used in large-scale, commercial coating operations. Triacetylcellulose (TAC) is the most widely used substrate for polarizers. Since TAC is soluble in a wide variety of solvents, only a few coating solvents may be used. In fact, only toluene and methylisobutylketone (MIBK) and mixtures of these with other solvents can be used in commercial applications without first applying a protective layer to the surface of the component.

With the cost of LCD units decreasing and the performance requirements increasing at a dramatic pace, the requirements for a solution cast negative birefringent film are becoming stricter. Currently, the basic requirements include a high value of negative birefringence, solubility in specific solvents, a flat or reversed wavelength dispersion curve, and low cost.

### 1. High Value of Negative Birefringence.

In most VA mode LCD, the overall retardation (R_{⊥}) requirement to the compensation film is about 200-300 nm. The common coating thickness is usually less than 10 μm. According to the formula:

R_{⊥}=Δn_{⊥}d

The minimum negative birefringence value of the film (Δn_{⊥}) must be no less than 0.01 when two coating layers are applied; and the minimum negative birefringence value of the film (Δn_{⊥}) must be no less than 0.02 when a single coating layer is applied.

### 2. Solubility

The polymer used to form the negative birefringent film must be soluble in toluene and/or MIBK or mixtures of these with other solvents.

### 3. Flat Dispersion Curve

Since the refraction indices are functions of wavelength (λ), the birefringence Δn also depends on wavelength. The dependence of birefringence on wavelength is called birefringence wavelength dispersion. The wavelength dispersion curve of a compensation film is a very important factor in optimizing the performance of an LCD. Most of the previous negative birefringent compensation films have displayed normal wavelength dispersion curves, i.e., the value of the birefringence decreased as the wavelength of light increased. A negative birefringent film with a normal wavelength dispersion curve may cause color distortions in some LCDs, such as vertical alignment (VA) LCDs, when viewed at high angles.

### 4. Low Cost

The cost of a solution cast negative birefringent film includes costs of both the polymer and the processing. To compete with stretched negative birefringent films, the overall cost of the polymer film and the substrate (TAC) should not be higher than the cost of a stretched negative birefringent film. This is particularly significant as the cost of stretched compensation films is continuing to decrease.

In Harris et al., U.S. Pat. Nos. 5,580,950 and 5,480,964, negative birefringent films prepared from rigid-rod aromatic polymers, including polyamides and polyimides, are described. The polymers are prepared from monomers containing twisted 2,2′-disubstituted biphenyl

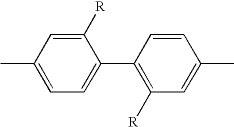

structures. The balance between solubility and backbone rigidity is achieved by the incorporation of the rigid twisted units in the polymer backbones. The twists in the rigid biphenyl unit hinder chain packing and interrupt the conjugation, thus, enhancing solubility and lowering the maximum UV absorption wavelength. However, films prepared from these polymers display normal wavelength dispersion curves and cost considerably more than comparable stretched films.

In JP 94-094917, a polyethersulfone is used to prepare solution cast negative birefringent films. The films display acceptable negative birefringence, however, the DP values are >1.10. The polymer is relatively inexpensive, but it is not soluble in

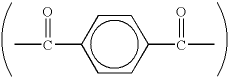

toluene and/or MIBK and mixtures of these solvents with other solvents.

In U.S. Pat. No. 6,853,424 B2, rigid 1,4-dioxophenylene units are incorporated in polyesters that can be solution cast into negative birefringent films. Several aromatic diol monomers are polymerized with terephthalic dichloride including 4,4′-(hexahydro-4,7-methanoindan-5-ylidene)bisphenol, 4,4′-(2-norbornylidene)bisphenol 4,4′-hexafluoroisopropylidene diphenol. However, homopolymers based on terephthalic dichloride display poor solubility. Although the solubility in other solvents is improved by replacing part of the terephthalic dichloride with isophthalic dichloride, the copolymers are not soluble in toluene and/or MIBK or mixtures of these with other solvents.

3,3′,5,5′-Tetramethyl-4,4′-biphenol and 2,2′,3,3′,5,5′-hexamethyl-4,4′-biphenol are extremely inexpensive aromatic diols because they are prepared by coupling reactions of readily available phenols.

In JP 1991-115324, assigned to Mistubishi Gas Chemical, aromatic polyesters are prepared by the interfacial polymerization of 3,3′,5,5′-tetramethyl-4,4′-biphenol or 2,2′,3,3′,5,5′-hexamethyl-4,4′-biphenol and a substituted isophthalic dichloride (5-tert-butylisophthalic dichloride) at room temperature. The polymers are soluble in

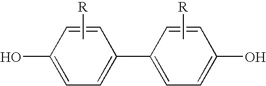

chloroform, dichloromethane, and THF. However, polymers are not soluble in toluene and/or MIBK and mixtures of these with other solvents.

In JP 1998-306146 and JP 1999-236495, assigned to Dai Nippon Printing, an aromatic polyester is prepared by the solution polymerization of 3,3′,5,5′-tetramethyl-4,4′-biphenol and isophthalic dichloride at an elevated temperature. Although the polymer is soluble in chloroform, 1, 1, 2, 2-tetrachloroethane, and NMP, it is not soluble in toluene and/or MIBK and mixtures of these with other solvents. Transparent films with thicknesses of about 80 μm can be obtained by casting a polymer solution (chloroform) on a glass plate. The use of this film as an optical compensation film is not suggested.

In JP 2007-077289, assigned to Dai Nippon Printing, the same aromatic polyester described above is obtained by interfacial polymerization at low temperature.

### SUMMARY OF THE INVENTION

The present invention is directed toward a negative birefringence film prepared from aromatic copolyesters. Colorless copolyester negative birefringent films can be prepared by solution coating or casting procedures from toluene and/or MIBK and mixtures of these with other solvents. These films display negative birefringence as cast and do not need to be subjected to stretching. By carefully selecting the monomer diols used to prepare the copolyesters, the solubility of the resulting copolymers and the optical properties of their solution cast film can be controlled. It is particularly surprising that a film can be cast from toluene and/or MIBK and mixtures of these with other solvents and display a negative birefringence of >0.02 and a DP of 0.90 to 1.10.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a plot of normalized dispersion curves of films based on PC/TMBP/BisAF copolymers;

FIG. 2 is plot of normalized dispersion curves of films based on TB-IPC/TMBP/BisAF copolymers;

FIG. 3 is plot of normalized dispersion curves of films based on IPC/HMBP/BisAF copolymers; and

FIG. 4 is plot of normalized dispersion curves of polyester copolymers film on TAC film.

### DETAILED DESCRIPTION OF THE INVENTION

The present invention is directed toward non-stretched, negative birefringent films prepared from aromatic copolyesters. The films are solution cast onto a substrate and achieve a negative birefringence value greater than 0.02 and a DP value between 0.90 and 1.10 without the need for stretching. Preferably, the copolyester is solution cast or coated onto a substrate, such as triacetylcellulose (or TAC), using toluene and/or MIBK and mixtures of these with other solvents to form a bilayer optical film. The birefingent polyester polymers can be joined with other layers and can be used to form single or multi-layer polymeric films. Although stretching is not needed, it can be done to further enhance the birefringence.

The resulting films are incorporated into liquid crystal displays (or LCDs) or LCD modules, and these structures are known in the art. See for example, Harris et al., U.S. Pat. Nos. 5,480,964 and 5,580,950 which are incorporated herein by reference, and U.S. Pat. No. 7,250,200 to Elman.

Copolyesters are prepared by polymerizing an aromatic diacid chloride selected from the following:
Isophthalic dichloride;
Terephthalic dichloride;
5-Tert-butyl-isophthalic dichloride;
   and two biphenols selected from:
3,3′,5,5′-tetramethyl-4,4′-biphenol;
2,2′,3,3′,5,5′-hexamethyl-4,4′-biphenol;
4,4′-hexafluoroisopropylidene diphenol

Representative and illustrative examples of the useful aromatic diacid dichlorides in the invention are
Isophthalic dichloride (IPC):

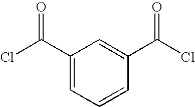

Terephthlic dichloride (TPC):

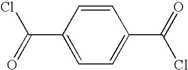

5-Tert-butyl-isophthalic dichloride (TB-IPC):

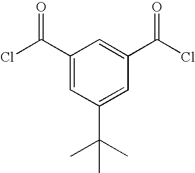

The bisphenols that are especially useful for the invention include:
3,3′,5,5′-tetramethyl-4,4′-biphenol (TMBP)

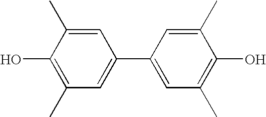

2,2′,3,3′,5,5′-hexamethyl-4,4′-biphenol (HMBP)

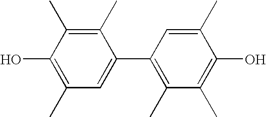

4,4′-hexafluoroisopropylidene diphenol (BisAF)

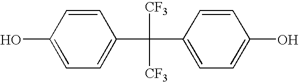

The copolyesters can be obtained by solution polymerization or interfacial polymerization of the dichloride with bisphenol.

### Example 1

This Example illustrates the general procedure to prepare a homopolyester from a dichloride and a bisphenol via solution condensation.

To a 50 ml four necked round bottom flask equipped with a mechanical stirrer, a nitrogen inlet and outlet are added 4 millimoles of bisphenol, 5.5 milliliters of dried 1,2-dichloroethane, and 1.5 milliliters of dried triethylamine. After the mixture is cooled to 5° C. with an ice-water bath, 4 millimoles of dichloride in 5.0 milliliters of 1,2-dichloroethane is added dropwise. The mixture is stirred at that temperature for 2 hrs, followed by another 1 hr at room temperature. The mixture is washed with diluted hydrochloric acid and the aqueous phase is removed. The residual polymer solution is washed with water. After the water is removed, the viscous polymer solution is poured slowly into methanol where the polymer precipitates as fibrils. After several methanol extractions, the polymer is dried.

### Example 2

This Example illustrates the general procedure to prepare a copolyester from a dichloride and a mixture of bisphenols via solution condensation.

To a 50 ml four necked round bottom flask equipped with a mechanical stirrer, a nitrogen inlet and outlet are added 4 millimoles of a mixture of bisphenols, 5.5 milliliters of dried 1,2-dichloroethane, and 1.5 milliliters of dried triethylamine. After the mixture is cooled to 5° C. with an ice-water bath, 4 millimoles of dichloride in 5.0 milliliters of 1,2-dichloroethane is added dropwise. The mixture is stirred at that temperature for 2 hrs, followed by another 1 hr at room temperature. The mixture is washed with diluted hydrochloric acid and the aqueous phase is removed. The residual polymer solution is washed with water. After the water is removed, the viscous polymer solution is poured slowly into methanol where the polymer precipitates as fibrils. After several methanol extractions, the polymer is dried.

### Example 3

This Example illustrates the general procedure to prepare a copolyester from a bisphenol and a mixture of dichlorides via solution condensation.

To a 50 ml four necked round bottom flask equipped with a mechanical stirrer, a nitrogen inlet and outlet are added 4 millimoles of bisphenol, 5.5 milliliters of dried 1,2-dichloroethane, and 1.5 milliliters of dried triethylamine. After the mixture is cooled to 5° C. with an ice-water bath, 4 millimoles of a mixture of dichlorides in 5.0 milliliters of 1,2-dichloroethane is added dropwise. The mixture is stirred at that temperature for 2 hrs, followed by another 1 hr at room temperature. The mixture is washed by dilute hydrochloric acid and the aqueous phase is removed. The residual polymer solution is washed with water. After water is removed, the viscous polymer solution is poured slowly into methanol and the polymer precipitates as fibrils. After soaked with methanol several times, the polymer is dried.

The solubility of the copolyesters was determined in toluene, MIBK, and mixtures of these with other solvents. The solubility of the copolyesters was also determined in cyclopentanone. The casting of cyclopentanone solutions of the copolyesters on glass plates can be carried out rapidly. The optical properties of films prepared by this facile procedure provide an indication of the optical properties of the films when cast on TAC from toluene and/or MIBK and mixtures of these with other solvents. The dilute solution intrinsic viscosities [η] of the copolyesters were determined in cyclopentanone using a capillary viscometer (Polyvisc Automatic Viscometer by Cannon Instrument Company) at 30° C. The solubilities and [η] of the copolyesters are shown in the following tables.

TABLE 1
Properties of IPC/TMBP/BisAF copolyesters

| No | 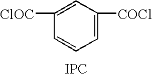 | 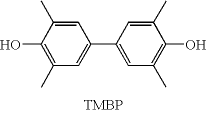 | 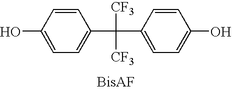 | Solubility CPN Toluene MIBK | | | [η] |
|---|---|---|---|---|---|---|---|
| 1 | 100 | 100 | 0 | Yes | No | No | 0.71 |
| 2 | 100 | 70 | 30 | Yes | No | No | 0.32 |
| 3 | 100 | 60 | 40 | Yes | Yes | No | 0.75 |
| 4 | 100 | 50 | 50 | Yes | Yes | No | 0.49 |
| 5 | 100 | 0 | 100 | Yes | Yes | Yes | 0.65 |

TABLE 2
Properties of TB-IPC/TMBP/BisAF copolyesters

| No | 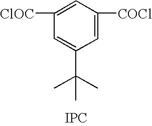 | 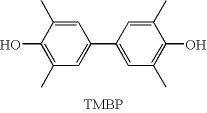 | 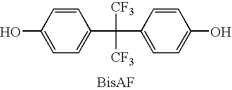 | Solubility CPN Toluene MIBK | | | [η] |
|---|---|---|---|---|---|---|---|
| 6 | 100 | 100 | 0 | Yes | No | No | 0.68 |
| 7 | 100 | 90 | 10 | Yes | Yes | Yes | 0.60 |
| 8 | 100 | 80 | 20 | Yes | Yes | Yes | 0.52 |
| 9 | 100 | 0 | 100 | Yes | Yes | Yes | 0.83 |

TABLE 3
Properties of IPC/TPC/HMBP copolyesters

| No | 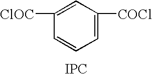 | 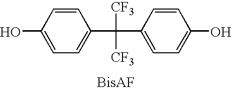 | 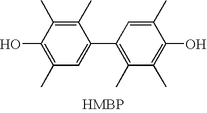 | Solubility CPN Toluene MIBK | | | [η] |
|---|---|---|---|---|---|---|---|
| 10 | 100 | 0 | 100 | Yes | No | No | 0.94 |
| 11 | 80 | 10 | 100 | Yes | Yes | No | 0.91 |

The copolyester films were prepared by the following two procedures. The copolyester was dissolved in cyclopentanone with a solids content between 4˜5%. After filtration, the solution was poured on a glass substrate. The solvent was allowed to evaporate at ambient temperature. The glass substrate containing the film was dried at 100° C. under reduced pressure. The polyester film was removed from the glass by dipping the substrate glass in water. The birefringence of the freestanding film was determined on a Metricon Prism Coupler 2010/M. Representative data are shown in the following tables.

TABLE 4
Optical properties of the freestanding films based on IPC/TMBP/BisAF

| No | 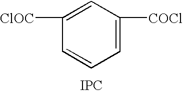 | 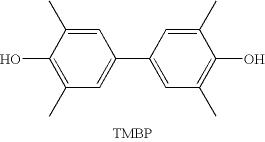 | 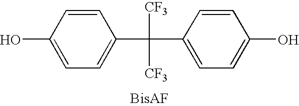 | Δn⁶³³ |
|---|---|---|---|---|
| 1 | 100 | 100 | 0 | −0.0358 |
| 3 | 100 | 60 | 40 | −0.0256 |
| 4 | 100 | 50 | 50 | −0.0253 |
| 5 | 100 | 0 | 100 | −0.0165 |

TABLE 5
Optical properties of the freestanding films based on TB-IPC/TMBP/BisAF

| No | 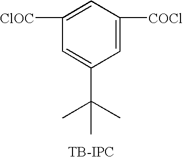 | 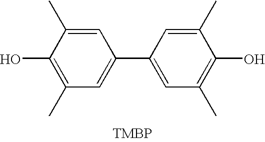 | 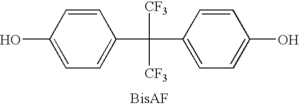 | Δn⁶³³ |
|---|---|---|---|---|
| 6 | 100 | 100 | 0 | −0.0224 |
| 7 | 100 | 90 | 10 | −0.0249 |
| 8 | 100 | 80 | 20 | −0.0229 |
| 9 | 100 | 0 | 100 | −0.0127 |

TABLE 6
Optical properties of the freestanding films based on IPC/HMBP

| No | 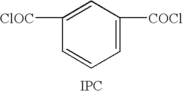 | 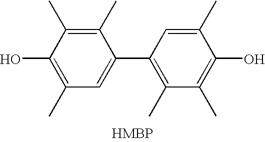 | 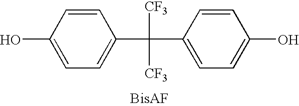 | Δn⁶³³ |
|---|---|---|---|---|
| 10 | 100 | 100 | 0 | −0.0287 |
| 11 | 100 | 90 | 10 | −0.0281 |
| 12 | 100 | 80 | 20 | −0.0280 |

Freestanding films were also made by dissolving the copolyester in toluene or a mixture of this solvent with other solvents with a solids content between 4˜5%. After filtration, the solution was poured on a glass plate. The solvent was allowed to evaporate at ambient temperature. The film was peeled off the glass plate and dried under reduced pressure. The retardation and the dispersion curve of the negative birefringent film were determined on a VASE® Ellipsometer from J. A. Woollan.

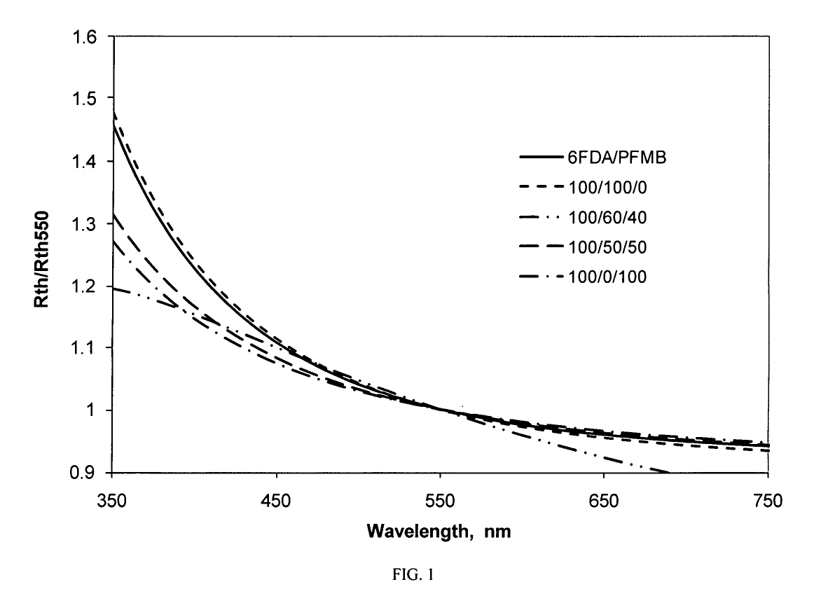

The normalized dispersion curve, which is the curve based on the value of Δn/Δn⁵⁵⁰ ratio was used to illustrate the flatness of the dispersion curve. Four representative negative birefringence films based on IPC/TMBP/BisAF copolymers are illustrated in the following FIG. 1. The polymer structures and DP values are shown in Table 7. For comparison, the curve and the data of the birefringence film based on 6FDA/PFMB polyimide also are shown in the figure and the table.

TABLE 7
Optical properties of the freestanding films based on IPC/TMBP/BisAF copolymers

| No | 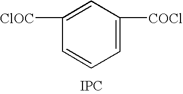 | 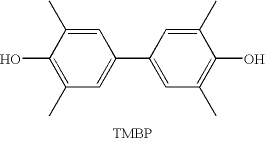 | 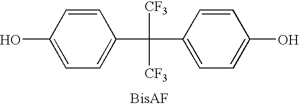 | DP |
|---|---|---|---|---|
| 1 | 100 | 100 | 0 | 1.115 |
| 3 | 100 | 60 | 40 | 1.100 |
| 4 | 100 | 50 | 50 | 1.084 |
| 5 | 100 | 0 | 100 | 1.075 |

| | |
|---|---|
| 6FDA/PFMB polyimide | 1.108 |

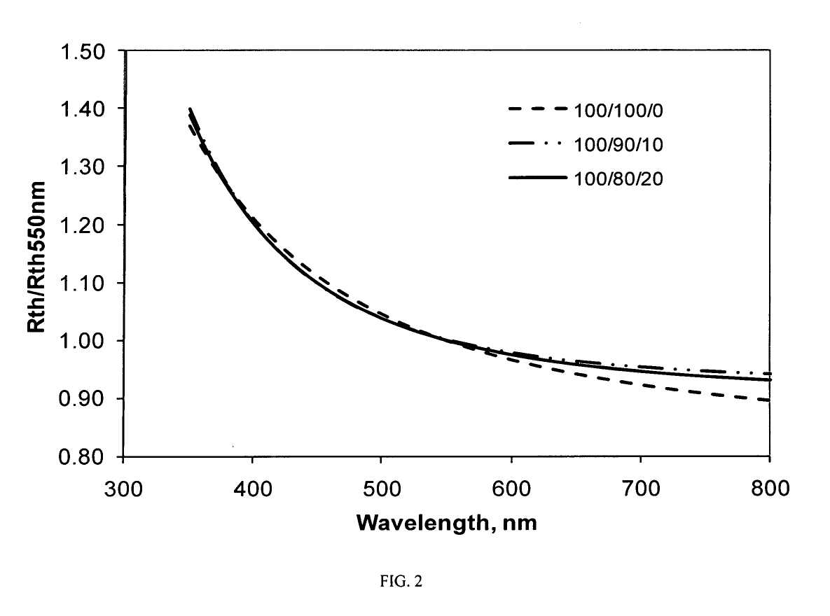

The dispersion curves of three representative negative birefringence films based on TB-IPC/TMBP/BisAF copolymers are illustrated in the following FIG. 2. The polymer structures and DP values are shown in Table 8.

TABLE 8
Optical properties of the freestanding films based on tB-IPC/TMBP/BisAF copolymers

| No | 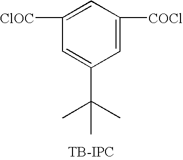 | 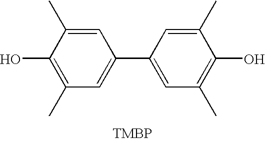 | 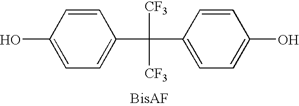 | DP |
|---|---|---|---|---|
| 6 | 100 | 100 | 0 | 1.111 |
| 7 | 100 | 90 | 10 | 1.096 |
| 8 | 100 | 80 | 20 | 1.098 |

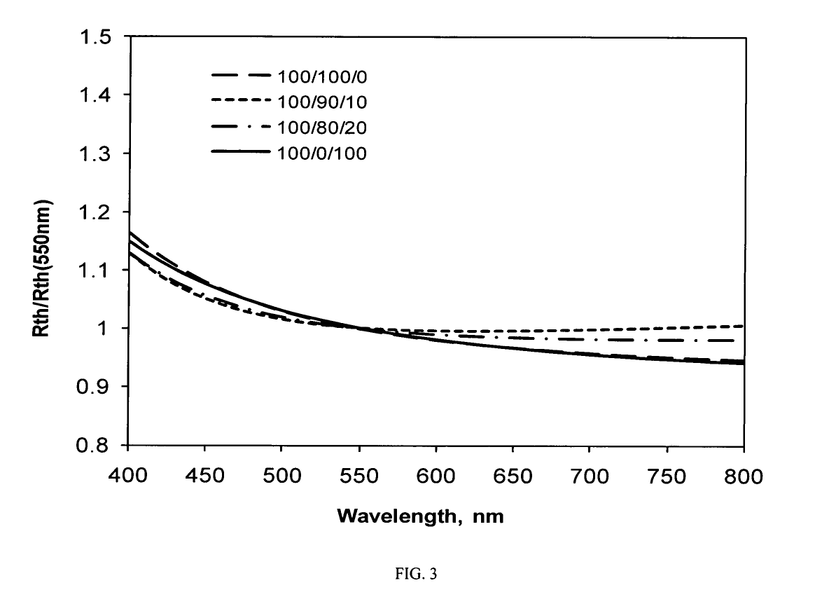

The dispersion curves of three representative negative birefringence films based on IPC/HMBP/BisAF copolymers are illustrated in the following FIG. 3. The polymer structures and DP values are shown in Table 9.

TABLE 9
Optical properties of the freestanding films based on IPC/HMBP/BisAF copolymers

| No | 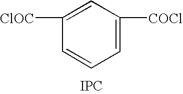 | 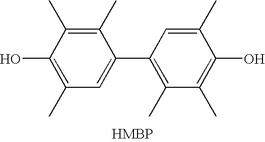 | 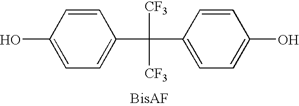 | DP |
|---|---|---|---|---|
| 10 | 100 | 100 | 0 | 1.079 |
| 11 | 100 | 90 | 10 | 1.050 |
| 12 | 100 | 80 | 20 | 1.056 |
| 5 | 100 | 0 | 100 | 1.075 |

The copolyesters were coated on TAC using the following procedure: the copolyester was dissolved in toluene or a mixture of the solvent with other solvents with a solids content between 4˜5%. After filtration, the solution was poured on a TAC film. The solvent was allowed to evaporate at ambient temperature. [TAC film thickness: 80 μm, retardation value at 633 nm (Rth⁶³³): 57 nm, birefringence at 633 nm (Δn⁶³³): −0.000069].

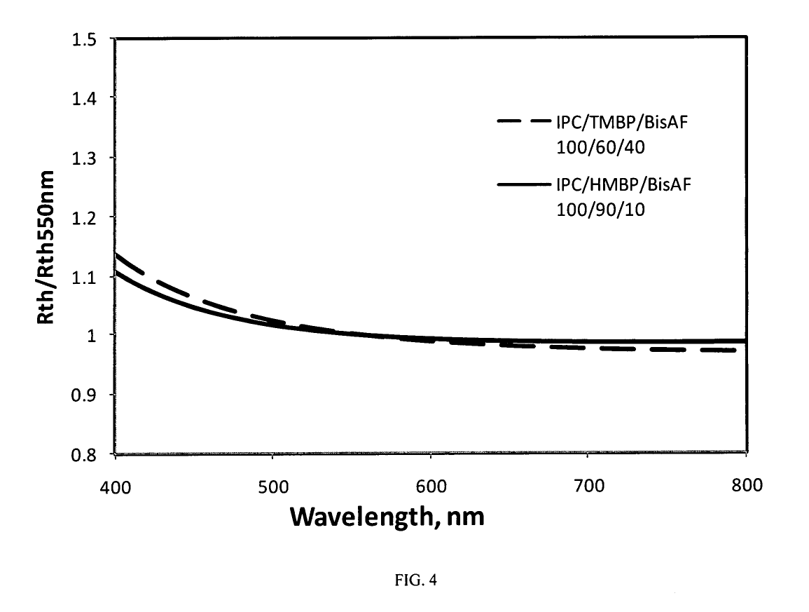

The following example illustrated the coating procedure of polyester on TAC: 0.50 g of copolymer was dissolved in a mixing solvent containing toluene (3.5 g), cyclopentanone (0.75 g) and methylethylketone (0.75 g). After filtration, the polymer solution was cast on a TAC film, and the solvent was evaporated slowly. The thickness (d) of polyester film, the combined retardation value (Rth⁶³³), and DP of the polyester film/TAC film are given in the Table 10. The dispersion curve and normalized dispersion curve are shown in FIG. 4.

TABLE 10
Retardation value and DP of the polyesters on TAC films

| | | | Rth⁶³³ | |
|---|---|---|---|---|
| No | Composition | d (μm) | (nm) | DP |
| 3 | IPC/TMBP/BisAF = 100/60/40 | 5 | 253 | 1.062 |
| 11 | IPC/HMBP/BisAF = 100/90/10 | 12 | 241 | 1.054 |

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. The claims alone are intended to set forth the limits of the present invention.

What is claimed is:

1. A non-stretched, negative birefringent copolyester film, which has been solution cast from toluene and/or MIBK and mixtures of these with other solvents on a substrate, and has a Δn_{⊥} of >0.02 and a DP between 0.90 and 1.10.

2. The copolyester film of claim 1 wherein the copolyester film is the reaction product of aromatic copolyesters.

3. The copolyester film of claim 1 where the copolyester is prepared from an aromatic diacid dichloride and two aromatic diols.

4. The copolyester of claim 1 wherein the copolyester is prepared from an aromatic diacid dichloride and two aromatic diols and the diacid dichloride is terephthalic dichloride or isophthalic dichloride.

5. The copolyester of claim 1 wherein the copolyester is prepared from an aromatic diacid dichloride and two aromatic diols and the aromatic diols are selected from 3,3′,5,5′-tetramethyl-4,4′-biphenol (TMBP), 2,2′,3,3′,5,5′-hexamethyl-4,4′-biphenol (HMBP) and/or 4,4′-hexafluoroisopropylidene diphenol (BisAF).

6. An LCD module containing the film of claim 1.

7. A bilayer optical film consisting of the copolyester film of claim 1 and TAC film.

8. An LCD module containing the bilayer optical film of claim 7.
